(19) United States
(12) Patent Application Publication
(10) Pub. No.: US 2002/0169543 A1
(43) Pub. Date: Nov. 14, 2002

(54) Long distance routing

(76) Inventor: Ronald L. Blewitt, Lone Tree, CO (US)

Correspondence Address: J. Mark Smith, Dorr, Carson, Sloan & Birney, P.C., 3010 East 6th Avenue, Denver, CO, 80206, US

(21) Appl. No.: 10/114,817

(22) Filed: Apr. 2, 2002

Related U.S. Application Data
(60) Provisional application No. 60/280,541, filed on Apr. 2, 2001.

(51) Int. Cl. G01C 21/34

(52) U.S. Cl. 701/202; 701/209

(57) ABSTRACT

An improved method and apparatus for searching for a least-cost route between point A and point B by using a modified Dijkstra algorithm simultaneously searching from both points A and B. The method ranks the roadway segments by relevant characteristics and conducts the Dijkstra search. As the search progresses viable and promising links are stored. As the number of options reaches a certain number, less promising options or options that are deemed less valuable are discarded. Thus, leaving a small quantity of segments for future search steps. The ranking may depend on quality of road section, whether a highway or expressway. A secondary rank, to differentiate road segments of equality is done based upon distance from the end points.

The inventor, Ronald L. Blewitt, claims priority based on Provisional Patent Application Ser. No. 60/280,541, filed Apr. 2, 2010, entitled LONG DISTANCE ROUTING, our Docket No. S170P.

### AREA OF THE INVENTION

The present invention relates to generation of point-to-point routes on a transportation network. More specifically, the invention provides various methods and apparatus for gradually and automatically suppressing use of secondary roads when exploring route alternatives increasingly distant from either of the two route endpoints. Benefits include the production of point-to-point routes of superior quality while minimizing the amount of computation required. While these benefits are greatest for long-distance routing, they are already apparent when routing between route endpoints only a mile or two apart.

### BACKGROUND OF THE INVENTION

The standard approach for generating least-cost point-to-point routes is to utilize Dijkstra's algorithm [see Introduction To Algorithms, Thomas H. Cormen et al, 1990; ISBN 0-07-013143-0, Chap. 25, incorporated herein by reference] to find the route for which the overall travel cost (travel distance, travel time, etc.) is a minimum. Dijkstra's algorithm accomplishes this by systematically exploring each and every street segment that might conceivably comprise the least-cost route from point A to point B. More precisely, Dijkstra's algorithm operates on a graph of vertices and edges representing the road network, and specifies how to systematically obtain minimum travel cost to graph vertices increasingly remote from the vertex at A. Eventually, the minimum travel cost from A becomes known for the vertex at B, costs having already been propagated from all vertices closer to A, and the costs propagation phase terminates.

At this point, the minimum travel cost to B from A is known, as is the minimum travel cost from A for every vertex closer to A than B. This set of information is sufficient to discover all intermediate vertices along a least-cost route from A to B. The least-cost route discovery phase commences by starting at B, then discovering which of the nearby vertices reachable by traversing a single graph edge has a minimum cost from A and a cost from B which, when summed, yield the already-known minimum travel cost to B from A. (If more than one nearby vertex meet this criterion, select either one.) Iterating this process allows one to sequentially discover all of the vertices along a least-cost route from A to B. As one might expect, the discovery phase terminates when iterating yields the vertex at A.

In order to reduce the amount of computation, routes between geographically distant endpoints are usually generated using a small subset of the entire road network that contains only major roads and highways, or perhaps only major highways. This approach requires estimating the distance between the route endpoints and/or the proximity of the route endpoints to the highway network, then using these distance estimates to decide at the outset whether to use the entire road network or a road-network subset. Estimating either of these travel distances before actually traversing the road network is problematic, since natural and man-made barriers often interpose.

Further disadvantages of this multi-option strategy are: (1) there is no one best option for many routes, since long-distance routes often begin and end at locations far from the nearest highway; and (2) in urban areas especially, highways-only routing can produce unnecessarily circuitous routes, even when both route endpoints lie on or near highways.

Among the past methods of solving some of these problems are shown by U.S. Pat. No. 5,899,955 Yagyu, U.S. Pat. No. 5,410,485 Ichikawa, and U.S. Pat. No. 5,513,110 Fujita. These methods generally rely upon separate map data bases based on two or three hierarchies of roadways. A top tier may include interstate highways and the lower tier including all roadways and intersections.

These methods usually start at the end point on the lowest tier and migrate to higher tiers based on some criteria.

In Yagyu (U.S. Pat. No. 5,899,955), the process is determined by a given radius from the end points. In Ichikawa (U.S. Pat. No. 5,410,485), the determination is based on whether the area to be searched is urban or suburban, based on a density calculation, and if urban a heuristic method is used to select routes. Fujita (U.S. Pat. No. 5,513,110) uses sections and subsections simultaneously to calculate the route by trying to encompass the end points then going to lower hierarchies to connect the end points with the road system.

These methods do not provide for simultaneous propagation on two or more tiers in the hierarchy.

### SUMMARY OF THE INVENTION

The present invention provides methods and apparatus for generating complete end-to-end routes over distances both large and small, uses the unabridged road network, and achieves computational economy over longer routes by ignoring more and more of the lower-ranking roads in areas geographically distant from the travel origin and travel destination. Each street segment in the road-network database is presumed to bear a rank, with limited-access highways ranked highest and neighborhood streets ranked lowest.

The present invention models the road network as a graph of edges and vertices, applies Dijkstra's algorithm to both route endpoints simultaneously, provides a criterion for determining when a graph vertex on a least-cost route has been found, and provides a method for subsequently constructing an entire least-cost route passing through that graph vertex. Dijkstra's algorithm operates on a graph with nonnegative edge costs, and systematically traverses graph edges to generate minimum-cost values between some starting vertex and other graph vertices located at ever greater “distances” from that starting vertex. At any instant, the algorithm maintains, for each route endpoint, a prioritized queue of vertices from which further minimum costs can soon be propagated; in the algorithm's pure form, all route possibilities are explored during the costs propagation phase, and each queue tends to grow linearly with distance from the starting vertex.

An essential feature of the present invention is that it limits the number of graph vertices retained in each costs propagation queue to some maximum value, and provides an additional prioritization scheme for determining which vertices are to be discarded whenever that maximum value is exceeded. The preferred prioritization scheme is based primarily upon the relative ranks of the vertices eligible for costs propagation, and secondarily upon their relative proximity to the other route endpoint. Specifically: (1) vertices of lower rank are discarded first; (2) among vertices of equal rank, vertices more distant from the other route endpoint are discarded first. The rank of each graph vertex is derived from the rank of the associated street segment.

Whenever the quantity of vertices in either costs propagation queue exceeds some maximum value, all excess vertices are immediately discarded from that costs propagation queue. For very short routes, that maximum value may never be exceeded, in which case no vertices are discarded regardless of rank, and the short route so generated is truly optimal. For longer routes, of course, lower-ranking vertices are eventually discarded, so that the middle portions of longer routes avoid street segments of lower rank, and progressively more so in regions geographically remote from either route endpoint. Even so, this prioritization scheme assures that routing possibilities are always exhaustively explored in the immediate vicinity of both route endpoints, even when the overall route is very long.

In the preferred embodiment, all vertices in the two costs propagation queues, except for those of the highest rank, are subject to being discarded during costs propagation. In this embodiment, vertices associated with limited-access highways are always retained, and some vertices of lesser rank are always retained as well. The preferred embodiment also retains fewer and fewer vertices of lesser rank as costs propagation proceeds, in order to further reduce the amount of computation required for very long routes. Specifically, for each starting vertex, it discards some of the vertices in the corresponding costs propagation queue whenever their number exceeds some large number (like 100,000 or 1,000,000) divided by the cumulative number of vertices propagated from that starting vertex so far.

In another embodiment, all costs propagation vertices, regardless of rank, are subject to being discarded. With the upper limit on the number of vertices retained in each queue still varying as the reciprocal of the total number of vertices propagated from that queue so far, the total computation time now tends to increase logarithmically with overall route length. This implementation tends to use limited-access highways exclusively at distances very far from either route endpoint, and may therefore falter if spurs in the limited-access highway network degenerate into roads of lesser rank. To avoid intermittent routing failure, this embodiment requires that the street segments be pre-ranked somewhat differently, so that the road-network subset consisting of only highest-ranking street segments contain no spurs.

A further understanding of the nature and advantages of the present invention may be realized by referring to the remaining portions of the specification and the drawings.

### BRIEF DESCRIPTION OF THE DRAWINGS

FIG. 1 shows travel costs being propagated from both route endpoints, a variation upon Dijkstra's algorithm. FIG. 2 shows how propagation of travel costs from endpoint A initially occurs along road segments of all ranks, then progressively confines itself to higher and higher ranking road segments as travel costs from A are propagated to vertices increasingly distant from A.

### DESCRIPTION OF THE PREFERRED EMBODIMENT

The present invention (1) gradually and automatically suppresses use of roads of lesser rank when exploring route alternatives increasingly distant from either of the two route endpoints, and (2) propagates travel costs from each route endpoint independently, in order to identify which route, of the many routes that avoid all of the suppressed street segments, has the smallest end-to-end travel cost.

Propagation of travel costs:

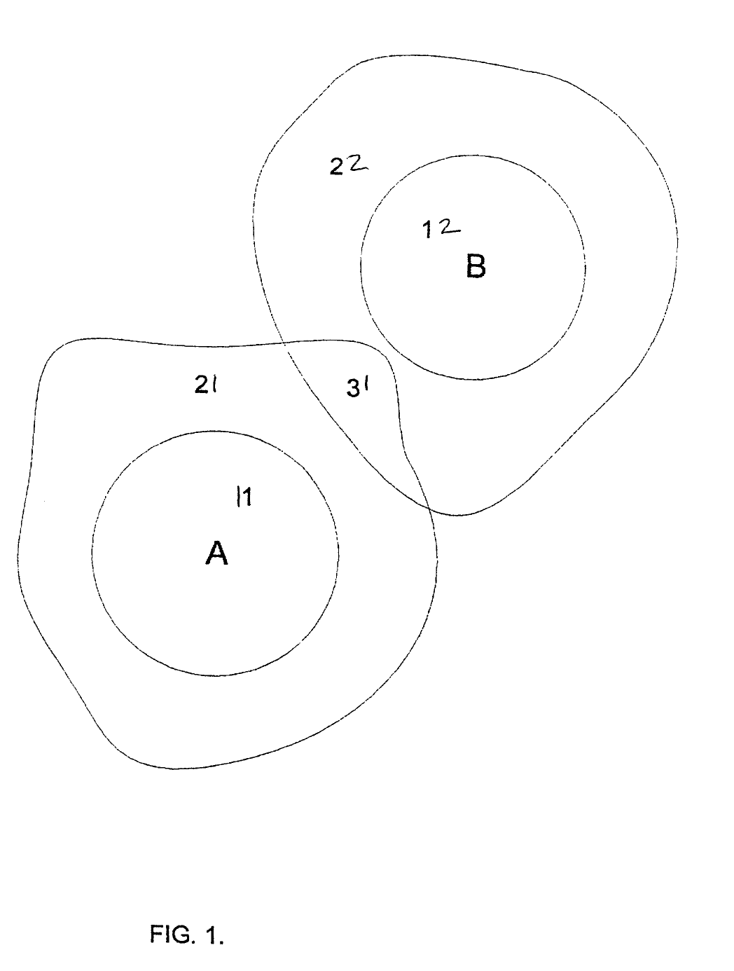

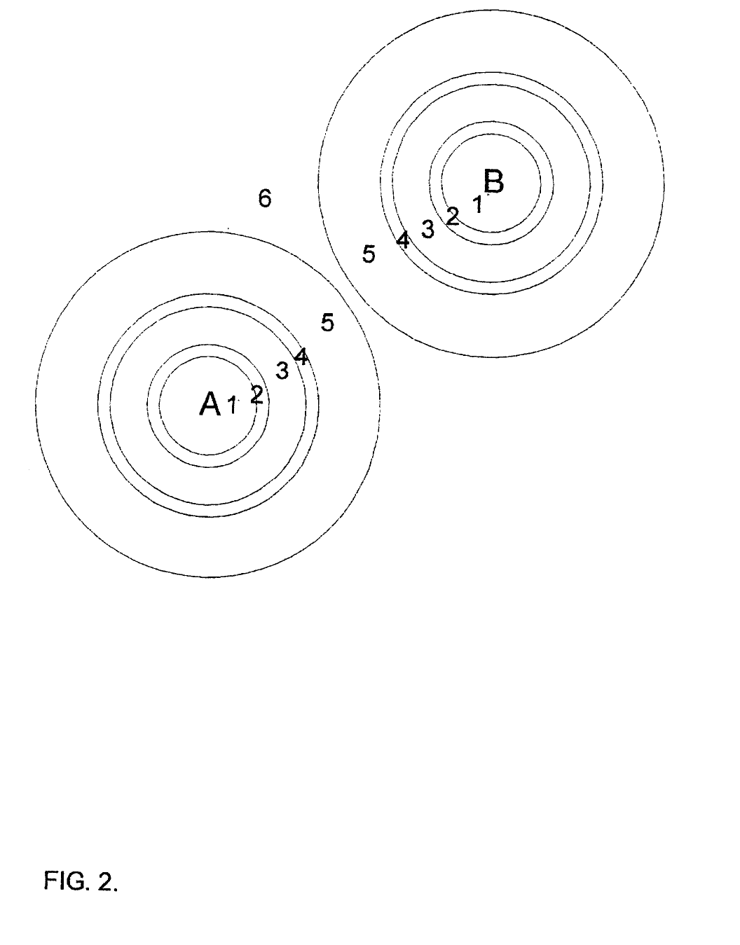

Travel costs are propagated outward from both route endpoints, starting with the vertex at route endpoint A, then the vertex at route endpoint B, then back to one of the vertices nearest to A, then to one of the vertices nearest to B, and so on. FIG. 1 shows an intermediate stage in this propagation process.

Area 11 is representative ofthe area where minimum travel cost from point A is known.

Area 12 is representative of the area where minimum travel cost from point 13 is known.

Area 21 is the area in which the travel costs from A are known.

Area 22 represents the area where travel costs from B are known.

Area 31 represents the area where travel costs to both A and B are known.

Propagation of travel costs from both route endpoints represents a modification of Dijkstra's algorithm. Instead of simply propagating from route endpoint A until the minimum travel cost from A is known for the vertex at route endpoint B, it is necessary to execute the following sequence each time the costs propagation process produces a travel cost to some vertex for which a travel cost from the other route endpoint is already known: (1) sum the two costs to obtain a travel cost from A to B; (2) if this sum is less than any previous sums so obtained, retain this smaller end-to-end travel cost Cab (cost A B) along with the identity of the vertex Vab (vertex A B) where this smaller end-to-end travel cost was obtained.

In order to detect when the costs propagation phase can be terminated, it is necessary to know how far out (in terms of travel cost) from each route endpoint the costs propagation process has proceeded. Following Dijkstra's insight, travel costs from A (or B) are propagated from a vertex only after travel costs from A (or B) have been propagated from all vertices nearer to A (or B), so that one can be sure that each travel cost being propagated is a minimum cost. By noting the travel cost to each vertex as it comes up for costs propagation, one can maintain current knowledge of the two travel cost thresholds below which travel costs are known with certainty to be minimum costs: Ta (for travel costs from A), and Tb (for travel costs from B).

Therefore, each time travel costs from A (or from B) are propagated from a vertex, (1) use the travel cost to that vertex to update the appropriate travel cost threshold (Ta or Tb), and (2) terminate costs propagation when Ta and Tb sum to a value equal to or greater than the current value of Cab, the smallest end-to-end travel cost from A to B seen so far. The rationale for termination is that further propagation will not uncover any route with end-to-end cost less than Cab.

Upon termination of the costs propagation process, the smallest end-to-end travel cost seen so far (Cab) is the minimum travel cost from A to B, and the associated vertex Vab is one of the vertices on a least-cost route from A to B. Furthermore, the two travel costs to Vab (from which Cab was computed) are both minimum travel costs, so that minimum travel cost from A and minimum travel cost from B are both known for vertex Vab. With this information, discovery of the least-cost subroute from A to Vab (using minimum travel cost from A at vertex Vab) and from Vab to B (using minimum travel cost from B to Vab) is straightforward, and the least-cost route from A to B, via Vab, is obtained by conjoining these two subroutes.

Suppression of lesser roads:

The preferred embodiment of this invention never suppresses costs propagation from vertices associated with limited-access highways. Therefore, the description that follows only applies to lower-ranking street segments and their associated vertices. FIG. 2 shows how propagation of travel costs from A initially occurs along road segments of all ranks, then progressively confines itself to higher and higher ranking road segments as travel costs from A are propagated to vertices increasingly distant from A.

In FIG. 1 the area of 1 or both A and B makes use of all roads to determine the route no matter what rank the roads are.

Areas depicted as 2 eliminates some minor roads.

Areas 3 eliminates all minor roads.

Area 4 eliminates all minor roads and some major roads.

Area 5 eliminates all minor and all major roads

Area 6 eliminates all minor roads, all major roads and some highways.

In the preferred embodiment the limited access highways are never eliminated or ignored.

Although travel costs propagation from A and from B occur concurrently, the mechanism for suppressing use of lesser roads is implemented identically but independently for the two costs propagation processes. For sake of brevity, the language of the following paragraphs only describes how the preferred embodiment of the invention suppresses use of street segments of lesser rank as travel cost from A is propagated to vertices increasingly distant from A.

Whenever cost from A is propagated to a vertex V for the first time, that vertex is placed in a prioritized “live” vertices queue. (This queue is separate from the prioritized queue used by Dijkstra's costs propagation algorithm.) Prioritization within the live-vertices queue is determined primarily by the rank of the street segment associated with each vertex, and secondarily by each vertex's distance from the other route endpoint B. This is accomplished by computing a composite distance-from-B score that is very much dominated by the rank of the street segment, but also takes into account the distance of the vertex from B:

score=rank*(1000 kilometers)+(distance from V to B).

The above formula assumes that roads of lower rank, such as neighborhood streets, bear the highest numerical rank. Vertices with higher scores are positioned closer to the front of the queue, so that they are will be the ones that are discarded first.

Any time the live-vertices count exceeds the currently allowed number of live vertices, the vertex at the front of the live-vertices queue is removed from that queue and also from the costs propagation queue used by Dijkstra's algorithm. This process is repeated until the live-vertices count no longer exceeds the current allowed number of live vertices. Conversely, each time that travel costs from A are propagated from a vertex, that vertex is also removed from the live-vertices queue.

The apparatus to accomplish the method makes use of storage means for collecting data on roads and their relevant characteristics, such as whether local roads, two lane, one way, speed limit, traffic control devices, whether highway and if so expressway, limited access or not, for highway whether it has spurs or not, represented by nodes and links with costs of travel. A CPU with the ability to access the storage unit for requested data and to process the search method as outlined herein, an input means to allow a origination and destination points to be entered, an output means to display the results of the search, a means for storing the search method program and memory means for working on the search and to store interim search results for the search method disclosed.

The apparatus to process the program of the search method as outlined accesses the relevant geographic area as determined by the input information of the origination and destination points, and by use of the program and a CPU identifies all roadways regardless of rank in the hierarchy, plus their costs. The program operates as set forth in the methods outlined with a result of a best path in accord with the characteristics chosen and output means for accessing the result. The access, input and output may be had on a CPU and memory at the query location, i.e. in a car or at a dispatch station, or it may connect the user to a remote CPU by wireless or land line connection, or by way of the worldwide web.

### CONCLUSION

While the invention has been particularly shown and described with reference to specific embodiments thereof, it will be understood by those skilled in the art that the foregoing and other changes in the form and details may be made therein without departing from the spirit or scope of the invention.

What is claimed is:

1. A route-finding method that dynamically manages the quantity and quality of the route leads that are concurrently propagated to obtain a least-cost route between two points (Point A and Point B) using Dijkstra's algorithm; route leads are created and selectively retained as follows:
a) route leads are initiated concurrently at both route endpoints (Point A and Point B); as route leads are extended or propagated one road segment at a time, the route leads radiating from each endpoint generally grow in both length and number,
b) to support selective retention of the most promising route leads, each route lead is scored for relative promise,
c) throughout the route leads propagation process, the number of retained route leads radiating from each route endpoint (A or B) is constrained to some maximum value; whenever that number is exceeded, only those route leads judged to be the most promising are retained, all others are discarded,
d) a candidate route from Point A to Point B is created each time a route lead from Point A contacts a lead from Point B, and the least-cost route is the route for which the costs associated with its road segments, when summed, produce a minimum overall route cost.

2. The method of claim 1b wherein the relative promise of each active route lead is determined by taking into account one or more characteristics of the road segment at its propagating end.

3. The method of claim 1b wherein a route lead's promise is based primarily upon the road class (faster roads are favored over slower roads) of the road segment at its propagating end, and secondarily upon the proximity of that newest road segment to the other route endpoint.

4. The method of claim 1c wherein the maximum allowed number of retained route leads declines, rather than remaining fixed, as propagation of route leads progresses.

5. The method of claim 1c wherein some route leads are not subject to being discarded, no matter how aggressively the other route leads are being discarded; if the road segment at the far end of the route lead is assigned to the road class containing the fastest roads, it is not even to be counted among the route leads subject to being discarded.

6. An apparatus for selecting a least cost route between two points (point A and point B) using road data comprising:
a) road data storing means wherein the road segment characteristics are stored;
b) a means to rank and store promising segments based on their characteristics during the search process;
c) a process means to search from both point A and point B for the least cost route and store the most promising segments wherein the promising segment storage means keeps only a maximum number that are ranked as most promising for future segment search and route costing, and which never eliminates any high level road segments; and
d) a costing means that selects the least cost route from the segments that are stored as the most promising segments.
